(19) United States
(12) Patent Application Publication
(10) Pub. No.: US 2019/0301725 A1
(43) Pub. Date: Oct. 3, 2019

(54) Nail Light

(71) Applicant: Robert Carl May, Pittsburgh, PA (US)

(72) Inventor: Robert Carl May, Pittsburgh, PA (US)

(21) Appl. No.: 16/392,194

(22) Filed: Apr. 23, 2019

Related U.S. Application Data
(63) Continuation of application No. 16/182,167, now abandoned.
(60) Provisional application No. 62/583,421, filed on Nov. 8, 2017.

(51) Int. Cl. F21V 33/00

(52) U.S. Cl. CPC F21V 33/0004; F21Y 2115/10

(57) ABSTRACT

This accessory product invention taps into an area of enhancing professional or personal work with finger/toe nail. This invention gives the user the freedom to bring to light the design or bling on the finger/toe nail at the users discretion.

The uniquely crescent moon shape design will allow the Nail Light to fit snugly with the bottom of the nail and the beginning of the finger or toe skin. The casing of the Nail Light can be manufactured in different colors. There is an option to decorate or cover the top of the Nail Light with a design or nail polish by the user.

Although this accessory product was invented for women it is not limited for women. Men too could also use the nail light for such things as dance clubs, entertainment, and freedom of expression.

This accessories product would be water resistant.

This nonprovisional patent application incorporates by reference in its entirety the contents of provisional patent application No. 62/583,421

### NOTICE OF COPYRIGHTS AND TRADE DRESS

A portion of the disclosure of this patent document contains materials that is subject to copyright protection. This patent document main shows and/or describes matter that is or may become trade dress belonging to the owner. The copyright owner and the trade dress owner have no objections to the facsimile reproduction by anyone of the patent disclosure as it appears in the patent and/or Trademark Office patent fees or records, but otherwise reserves all copyrights and trade dress rights whatsoever.

### REFERENCE

| | | |
|---|---|---|
| D544128 | June 2007 | Carro |
| D587832 | March 2009 | Bergmann |
| D618373 | December 2009 | Fukasawa |
| D575928 | August 2016 | Price |

### TECHNICAL FIELD

This invention enhances the perception of the finger/toe nail of both the user and viewer, and allows the nail polish and/or nail bling to take on a new perception and a change of usage.

### BACKGROUND

The opportunity to use light and/or colored light to enhance finger/toe nails for such things as design, personalization and statement making.

The present inventor, who describes fully in his claims, discloses a use of lighting and a way of application that is applied and removed without hindrance to the finger/toe nail.

### SUMMARY

The present invention adds a light source without the appearance of discomfort or interference with a simple application and removal. The invention will be parent from the following description.

In general, this accessories product, is comprised of a flexible rubber casing, LED lighting, battery, on-off click switch and adhesive. In general, in an aspect, the design of the rubber casing is in a crescent half moon shaped the basic size of the base of the finger/toe nail (sizes will slightly very). In general, in an aspect, the battery will be encased in the flexible rubber casing with the LED light in/on the side of the casing shining outward.

In general, in an aspect, the flexible rubber casing will be applied to the base of the nail so the LED light can shining up the nail's horizon illuminating the polish or bling.

In general, in an aspect, the flexible rubber casing will be held in place on the nail with the adhesive on the bottom of the flexible rubber casing.

In general, in an aspect, the flexible rubber casing will take the shape of the base of the nail to help conceal its application.

In general, in an aspect, the LED light will brighten and enhance the nail polish, the nail polish design and applied bling.

### BRIEF DESCRIPTION OF DRAWINGS

The accompanying drawling's illustrate the embodiments of the invention and, along with the description, serve to explain the principles of the invention according to its embodiments. The design, will show the particular embodiments that are illustrated in the drawings. The present invention is more fully described in the claims.

### DETAILED DESCRIPTION OF INVENTION

The originality of this invention comes from seeing women showing off their nail designs with their cell phone flashlights, often many times repeatedly. The thought of inventing a lighting device that shows nail design and nail bling became of interest to the inventor. The possibilities of putting light directly on the whole nail from the bottom of the nail became a reality after exploring the availability of its components.

By using a mold to make a small flexible rubber casing with a cavity in the middle (from front to back) and making the casing approximately the width of the bottom of the nail, a small LED light (on the side) connected to a tiny battery with an on-off switch (backside), could be placed into the cavity. The casing would then be sealed with a small rubber cover. There is adhesive added to the bottom to secure the rubber casing to the bottom of the nail. Thus inventing a totally original accessories product.

When the Nail Light is placed on the bottom of a finger/toe nail, the user would click the on-off switch to on to on activate the LED light. The LED light would then illuminate the horizon of the nail and any design or bling on the nail. The LED light would also be available in different colors at the user's discretion.

The user would have choices of how many finger/toe nails they would want to use the Nail Light on and the option of time to leave the LED light on or off.

### DESCRIPTION OF DRAWINGS

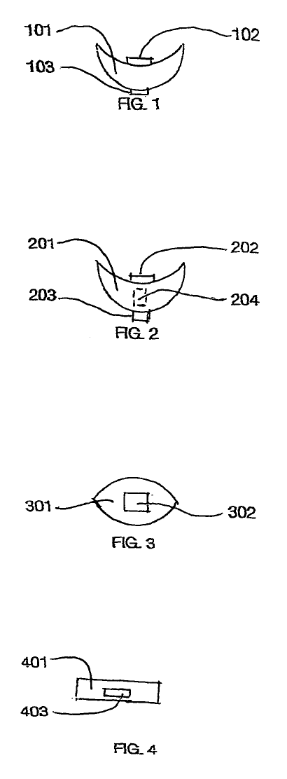

FIG. 1, Top

As shown in FIG. 1. The Nail Light (top). 101, rubber crescent moon shaped casing. 102, LED light. 103 on/off button.

FIG. 2, Bottom and Interior

As shown in FIG. 2. the Nail Light (bottom) 201, rubber crescent moon shaped casing with adhesive. 202, LED light. 203, on/off button. 204, interior battery.

FIG. 3, Front

As shown in FIG. 3. The Nail Light (front) 301, rubber crescent moon shaped casing. 302, LED light.

FIG. 4, Back

As shown in FIG. 4. The Nail Light (back). 401, rubber crescent moon shaped casing. 403, on/off button.

1. A accessory product for use to change the appearance and to enhance the finger/toe nails. This includes finger/toe nail polish, accessories and bling. This accessory product allows the user to display with light all art work, design work, nail polish work, accessories and bling that is on the users finger/toe nails. Options for personal preference and freedom of choice by using different colors of light by the user gives the onlooker a brighter and a different visual perception.

2. The accessory product of claim 1 wherein is made with rubber, LED lighting, battery, on-off switch and adhesive.

3. The accessory product of claim 2 wherein has a rubber casing with a unique crescent moon design.

4. The accessory product of claim 3 wherein has adhesive on the bottom.

5. The accessory product of claim 1 wherein has a LED light that brighten the horizon of the nail.

6. The accessory product of claim 5 wherein the LED light illuminates the art work, design work nail polish work and all accessories and bling.

7. The accessory product of claim 5 wherein the LED light would have different colors.

8. The accessory product of claim 2 wherein the battery is the power source for the LED lighting.

9. The accessory product of claim 2 wherein the on-off switch when pushed would engage the battery onto the back of the LED light and turn on. When the on-off switch is pushed a second time the battery would disengage from the LED light and turn off.
